(19) United States
(12) Patent Application Publication
(10) Pub. No.: US 2018/0206456 A1
(43) Pub. Date: Jul. 26, 2018

(54) Suet Mold Kit with Dual Headed Piston Ramrod

(71) Applicant: Robert Rebich, N. Huntington, PA (US)

(72) Inventor: Robert Rebich, N. Huntington, PA (US)

(21) Appl. No.: 15/417,133

(22) Filed: Jan. 26, 2017

(51) Int. Cl. A01K 39/01; A23K 50/70; A23K 40/20; A23N 17/00

(52) U.S. Cl. CPC A01K 39/0106; A23N 17/005; A23K 40/20; A23K 50/70

(57) ABSTRACT

The present invention is a suet making kit and method for forming suet plugs from a birdwatchers own customized suet mixture. With the instant invention suet plug manufacturing kit, suet mixtures may be shaped and sized to fit various cavity sizes and cavity shapes on a plurality of already existing different bird feeders. The kit provides the tools for making a feed suet plug of a predetermined shape, having a length dimension and a length-wise axis. The tools include a at least one ramrod having two pistons and a plurality of mold sets each having a cross-section with a substantially similar cross-section as a ramrod piston. A kit is selected so that the cross-sectional configuration of the feed suet plug made with the kit corresponds generally in size and shape to the cross-sectional configuration of the birdwatchers existing bird feeder.

### FIELD OF THE INVENTION

The present invention relates to a kit system and method for making suet plugs to feed wild birds, particularly to such a kit system where a cohesive bird feed, such as suet, can be conveniently formed into a shape so as to be conveniently inserted into a bird feeder as needed for consumption by the birds.

### BACKGROUND OF THE INVENTION

The present invention relates generally to feed plugs for providing a food source to wildlife including, but not limited to, wild birds and the like. Bird feeder suet is a cohesive mixture of hard fat mixed with seeds, grains, nuts and fruit that is often used as food for backyard wild birds.

People have been providing wild birds various types of bird feed for many years. There are many devices for effectively providing food for consumption by wild birds. Bird seed is a common type of food fed to wild birds, and quite commonly the seed is fed to the birds by placing it in a dispensing container such as a feeder sock, see U.S. Patent Application Publication No. 2013/0029005 (Augustin), published Jan. 31, 2013.

Bird feeders presently available generally provide for the storage of bird seed in a bin for distribution to trays for access by birds. The seeds in the bins fall by gravity onto the tray as seed is removed from the tray by a bird. The primary objection to this type of a dispensing system is the scattering of the seed from the tray by the birds resulting in considerable loss or waste of bird seed which falls to the ground.

Suet is also a popular feed for bird watchers to provide to wild birds. Suet bird feeders have been in use for years. U.S. Pat. No. 2,306,312 (Hyde) shows a bird feeder provided with openings into which cups of bird food may be placed. The device can be configured for clinging birds such as wood peckers, by providing perches for the birds.

The raw suet generally comprises a cohesive mass and can often be purchased from a butcher or meat market. A birdwatcher may mix into the suet a preferred bird seed such as peanuts, chips, sun flower chips and/or other bird favorites. A birdwatcher places the suet mixture at some bird feeding location, often by scooping it out of a container or package with a spoon or a knife and depositing it in some bird feeding receptacle, platform or the like. Alternatively, a birdwatcher may purchase an already formed cohesive suet plug purchased at a local pet supply store. These prepackaged suet plug products have limits on the variety of species of birds that they will attract. While some manufacturers produce suet based plugs made with seeds and/or fruits and flavorings throughout the suet, many type birds will not feed on a particular suet, for instance mutton suet, and/or certain seeds and fruits.

In the prior art suet is shaped and preformed into suet plugs. The suet plugs are then inserted into a bird feeder housing, see U.S. Pat. No. 6,817,313 (Ries et al.), Nov. 16, 2004. The bird feeder is often hung from a tree where birds are free to safely feed on the inserted suet plugs. U.S. Pat. No. 5,052,342 (Schneider) shows a suet-seed plug holder in which there is a panel, with an opening into which the suet-seed plug is placed, and a perch to accommodate the feeding bird.

A conventional suet bird feeder is comprised of a housing, a hole/cavity in the housing, and suet plug that is snugly positioned completely within the hole/cavity. Conventional suet plugs are typically comprised of hard animal fat combined with grains, peanut butter, nuts, fruit, seeds, sun flower chips and/or other bird favorites. Suet is a popular food for feeding birds, particularly in the winter, because the hard fat used to create the plugs is a highly-concentrated form of energy essential to maintain body heat.

Suet bird feeders are commonly comprised of replaceable rigid plug members that contain the suet mixtures that are removably inserted into a hole/cavity within a bird feeder housing structure. Suet is commonly formed into a consistent elongate cylindrical shape, referred to as suet plugs or suet logs.

There is a need in the industry for a system that permits a person to make suet plugs according to that individual birdwatcher's own mixture preference. Another consideration is that the person who is providing suet plugs for a bird feeder is able to do so conveniently. Also, it is desirable that the feeding system be arranged so that it does not take a great deal of skill or practice for the person to effectively use this system.

It is desirable, therefore, to provide a feed plug manufacturing system in a single kit that permits a birdwatcher with the ability to provide a food source for a variety of species.

### SUMMARY OF THE INVENTION

The present invention is an effective system of making bird feed suet plugs or logs, such as plain suet or suet having other bird feed mixed therein. The term plug as used subsequently herein shall mean both plug and log. This suet making system of the present invention has desirable features, such as ease and convenience in readily forming suet plugs from a birdwatchers own customized suet mixture. With the instant invention suet plug manufacturing kit, suet mixtures may be shaped and sized to fit various cavity sizes and cavity shapes on a plurality of already existing different bird feeders.

In the system of the present invention there is first provided a housing which has at least one bird feeding cavity recess with an outer end opening. The recess has a predetermined cross-sectional configuration and a lengthwise axis extending inwardly from the outer end opening. The cross-sectional configuration is substantially constant and extends from the opening to the rearward wall of the cavity.

There is provided a kit system for making a feed suet plug of a predetermined shape, having a length dimension and a length-wise axis. The suet plug has a substantially constant cross-sectional configuration perpendicular to its longitudinal axis. The cross-sectional configuration of the feed suet plug corresponds generally in size and shape to the cross-sectional configuration of the bird feeding recess/cavity so as to provide a snug friction fit. The suet plug has a first end and a second end and comprises a bird feeding material which is sufficiently yielding so as to permit it to be manually compressed and shaped, but still sufficiently stable and cohesive to maintain its shape under a more moderately applied manual force, such as applied to the suet plug during insertion into the cavity. A first end portion of the formed feed plug is inserted into the bird feeding cavity recess in a manner that the first end portion of the feed plug is retained in the recess.

A plug mold is selected from a suet molding kit that has a length proximate to, or moderately spaced from, the outer opening of the cavity recess so that at least the first end portion of the plug positioned in the cavity recess is exposed to be available to be eaten by birds.

At a later time after consumption of a first suet plug, another similar shaped plug can be made with the suet plug making kit and inserted into the cavity recess to be eaten by the birds. In one preferred form, the cavity recess has a cylindrical cross sectional configuration.

The suet plugs made with the kit system may have a first feed component selected from a group consisting of suet, suet-like material, and mixtures thereof. Also, the feed material can comprise a particulate second feed component, including but limited to bird seed, mixed together with the first feed component. With the present invention suet kit system, a birdwatcher can combine particular suet and particulate feed into a plug that would be a proper appetizing feed for the variety of bird found at the location of the bird feeder. Bird feed suet is not intended to be provided with the kit of the present invention but may be acquired and/or made independently by the birdwatchers.

The system of the present invention comprises a dual headed ramrod having two pistons having different cross-sections in combination with at least two molds having different cross-sections.

### BRIEF DESCRIPTION OF THE DRAWINGS

FIG. 1 is a perspective view of the present invention;

FIG. 2 is a cross-section of the present invention with a packed suet plug formed with a ramrod first piston and a cooperating first mold housing of the present invention;

FIG. 3 is a cross-section of the present invention with a packed suet plug formed with a ramrod second piston and a cooperating second mold housing of the present invention;

FIG. 4 is a perspective view of a suet plug forming kit of the present invention;

FIG. 5 is a perspective view of a suet bird feeder apparatus;

FIG. 6 is a side view of the of the present invention with the mold and ramrod assembly of FIG. 3 now turned upside down and the mold retracted along the axis of the ramrod to expose the newly formed suet plug for removal and use in a bird feeder.

### DETAILED DESCRIPTION OF THE INVENTION

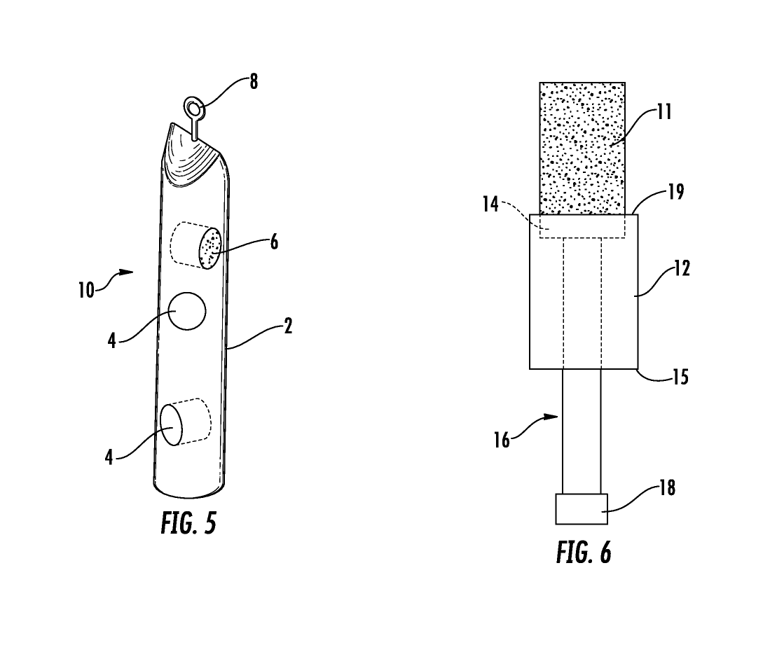

Referring to the drawings, FIG. 5 illustrates a bird feeder 10 in the general shape of a large sawed-off branch. The bird feeder includes a housing 2 having a plurality of cavity recesses 4 therein for receiving suet plugs. In FIG. 5 a suet plug 6 is shown positioned in the uppermost cavity recess 4. A means for hanging 8 the bird feeder from a tree or other appropriate structure is attached to the top of the bird feeder housing. Nail means or other well-known means in the art can be inserted through the wood piece and into the recess to retain the feed plug.

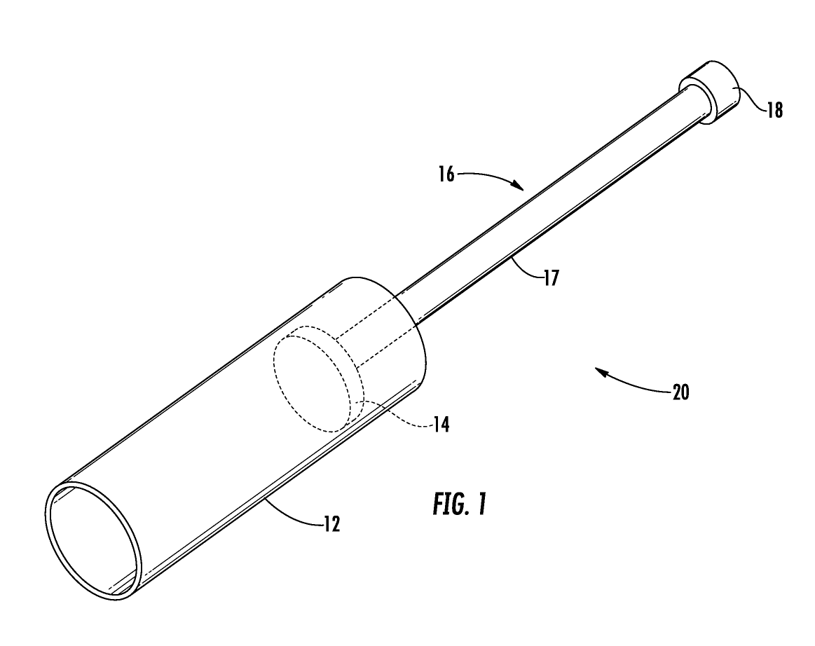

FIG. 1 illustrates a packing tool 20 for fabricating suet material into suet plugs. The packing tool 20 comprising a generally tubular mold member 12 and a two-headed ramrod 16. The tubular mold 12 having a self-sustaining shape and a substantially uniform cross-section substantially along its entire longitudinal axis. The ramrod 16 having a first piston 14 slidably received in the tubular member 12 and axially movable therein along a longitudinal axis of the tubular mold member 12. The first piston 14 is connected at one end of a shaft 17 and a second piston 18 is connected to the opposite end of the shaft 17. The first piston is slidably received in the tubular mold 12 and axially movable therein along a longitudinal axis of the tubular mold. Both the first piston 14 and second piston 18 each have a cross-section configured substantially similar to their cooperating molds cross-section and are designed to snugly slide therein.

In the industry suet plugs are prepackaged and sold in shapes and sizes to fit into the receiving cavities of bird feeders that have already been mass produced and put into use by birdwatchers. For instance, many cylindrical suet plugs on sale in the marketplace have diameters of 1¼″ and 1½″. These marketplace suet plugs may be made 2″, 3″ 4″ or 6″ long. Such prepackaged suet plugs placed for sale in commerce are intentionally dimensioned to fill those cavities in existing bird feeders that are in widespread use.

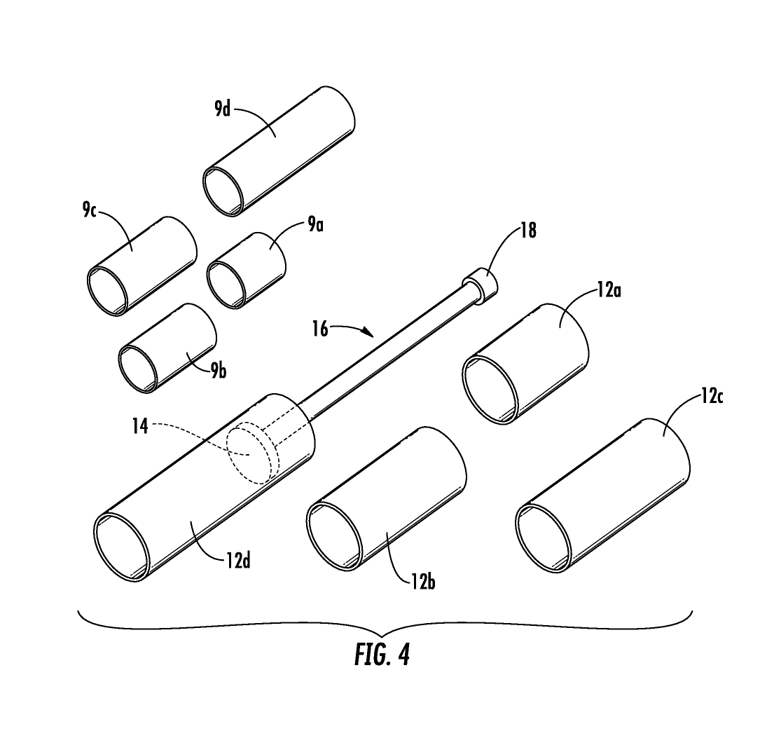

A description of the method of using the suet kit shown in FIG. 4 is set forth herein to make a suet plug for a bird feeder will now be described. A birdwatcher first selects from the present invention kit, see FIG. 4, the tubular mold (9a, 9b, 9c, 9d, 12a, 12b, 12c, 12d) which has a diameter and length corresponding to the dimensions of a particular bird feeder cavity recess 4 desired to be filled. Initially just the tubular mold 12 is placed on a flat surface in a longitudinally upright position. Next suet 11 is manually placed into the tubular mold 12; and upon filling the tube 12 it is then compressed downward with first piston 14. The tubular mold 11 is held steady with one hand on a suitable flat surface as a person manually grips the ramrod shaft 17 with the other hand and presses downward compacting the suet into a solid cohesive suet plug in the shape of the mold. Preferably configurable bird feed suet is added in successive amounts and packed after each increment of suet is supplied into the tubular mold 12. The suet may be added successively in various amounts or precisely measured amounts until a desired length of the plug is achieved. In one preferred method of forming a desired length plug, the mold is packed until the top surface of the piston 13 is coplanar with the top surface 15 of the tubular mold 12. Once suet has been packed into a mold so that these two elements surfaces are coplanar then a suet plug having a predetermined length is now ready for the removal.

By using such a coplanar orientation of these two-part surfaces as a visible guide mark, a person can readably observe that a suet plug having a predetermined length has been packed into the mold. As an artisan, would appreciate plural tubular molds 12 having different lengths can be used to provide obvious guide marks in forming suet plugs of a plurality predetermined desirable lengths.

Once the desired amount of suet has been placed and compressed within the tubular mold 12, see FIG. 3, the compacted suet, mold 12 and ramrod 16 are turned upside down. The second piston 18 opposite the ramrod suet packing piston 14 is now rested on the flat surface. Next, while holding the ramrod steady with one hand the tubular mold 12 is pulled down with the other hand until the surface 19 becomes coplanar with the first piston 14 face as seen in FIG. 6. Once in this coplanar position the newly formed suet plug is completely exposed in its entirety as can be seen in FIG. 6. While still holding the ramrod with the one hand the suet plug is grabbed with the other hand and removed. This newly formed bird feeder suet plug is now ready for use, storage or packaging.

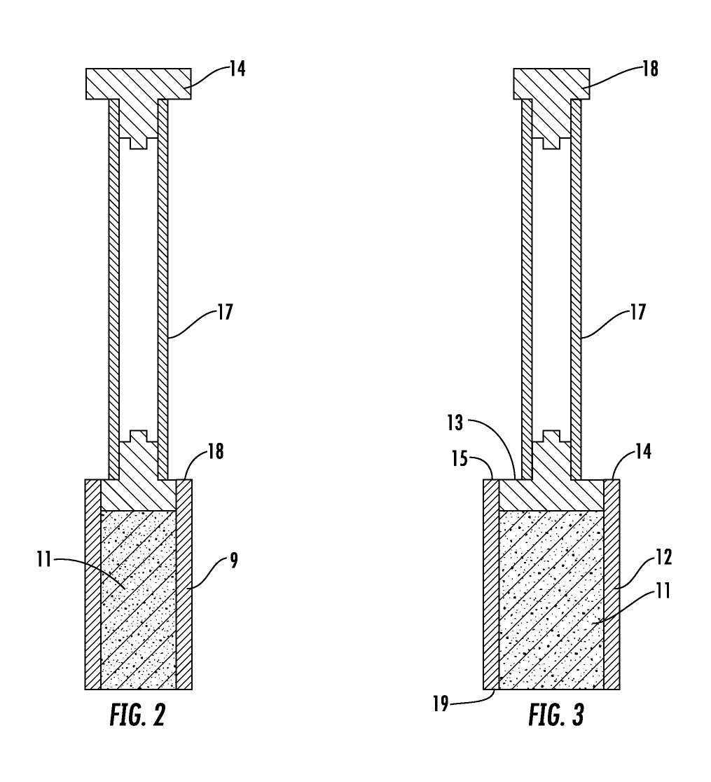

As described above the ramrod has a piston at each end. The first piston 18 and second piston 14 as seen in FIGS. 1-4 have different diameters. In FIG. 3 the larger first piston is used for packing suet into first mold 12. In FIG. 2 the smaller diameter piston 18 is shown for packing suet into a second mold 9 having a correspondingly smaller inner diameter.

In a first preferred kit of the invention first piston 14 has a diameter of 1⅜″ and second piston 18 has a diameter of 1 1/16″. Tubular molds 12 and 9 having corresponding inner diameters of 1⅜″ and 1 1/16″ respectively are provided together in a said preferred kit.

In another second preferred kit the dual-headed ramrod first piston 14 has a diameter of 1 1/16″ and a second piston diameter 18 of 15/16″ Likewise, as in the first kit tubular molds 12 and 9 having corresponding inner diameters of 1 1/16″ and 15/16″ respectively are provided together in a said second preferred kit.

In a third preferred kit a dual-head ramrod having pistons with diameters of 4″ and 3″ and corresponding molds are contemplated. Likewise, tubular molds 12 and 9 having corresponding inner diameters of 4″ and 3″ respectively are provided together in a said third preferred kit

FIG. 4 illustrates a suet plug molding kit comprising a dual-headed ramrod and eight total molds. Four of these molds 9a-9d having an inner diameter corresponding to second piston 18; and the other four molds 12a -12d having an inner diameter corresponding to first piston 14. As shown in FIG. 4 the diameter of each of the molds 9a-9d are the same, however they have different lengths. As shown in FIG. 4, the length of each the molds 9a-9d get progressively longer in alphabetical order. Similarly, the four molds 12a-12d have an inner diameter equal in size to first piston 14 and they can be seen as being progressively longer 12a-12d alphabetically.

Ramrod 16 and mold 12 can be made from the same or different materials including plastic, such as polyvinyl chloride. Pistons 14 and 18 are preferably plastic, most preferably injection molded plastic. Both the ramrod and mold can be made of any material suitable for holding birdfeed. The geometrical shape of the ramrod pistons is not limited, except that its external circumference should conform to the internal circumference of a mold. Thus, in the presently illustrated invention piston 14 is circular so as to conform with the cylindrical shape of the mold 12. Piston 14 should fit snugly within mold 12, so as to prevent liquids from seeping out of the mold during packing, and yet, should not be so snug as to hinder the piston 14 from sliding along the mold 12.

The shape of mold 12 is not limited to a cylinder. Other suitable shapes are contemplated that would have cross-section shapes that are, e.g., oblong, square, rectangular, triangular, polygonal and irregular. The shape, length and width of the mold 12 is dictated by the shape of the cavities on the bird feeder.

Different shaped pistons and molds are contemplated with different cross-sections such as square, rectangular, decorative patterns, symbolic even irregular shaped cross-sections. Different molds and ramrod pistons for creating suet plugs of different lengths and widths are contemplated as well.

It is further contemplated that a plurality of dual-headed ramrods and cooperating molds may be included in a suet plug manufacturing kit. A fourth preferred kit of the present invention, includes two ramrods having a total of four various piston cross-sections and four molds with cooperating similar cross-sections. In fifth preferred kit of the present invention the immediately above described kit would be modified so that for each said four different piston cross-sections having at least another different length mold for each different piston cross-section is included in the kit. Another sixth preferred kit is further contemplated having multiple ramrods with pistons having various cross-sections along with their corresponding multiple molds, includes for each different mold cross-section at least a plurality of different length molds.

This application—taken as a whole with the specification, claims, abstract, and drawings—provides sufficient information for a person having ordinary skill in the art to practice the invention disclosed and claimed herein. Any measures necessary to practice this invention are well within the skill of a person having ordinary skill in this art after that person has made a careful study of this disclosure.

Because of this disclosure and solely because of this disclosure, modification of this container with piston can become clear to a person having ordinary skill in this particular art. Such modifications are clearly covered by this disclosure.

What is claimed is:

1. A suet plug kit for creating one or more suet plugs comprising:
at least one first tubular mold having a longitudinal axis, and
at least one ramrod, wherein said ramrod has a longitudinal shaft and a first piston connected to one end of said shaft and a second piston connected at an opposite end of said shaft.

2. The suet plug kit of claim 1, wherein said first piston has a cross section and said at least one first mold has a substantially constant cross-section along said longitudinal axis, said first piston cross-section fits snugly in said at least one mold.

3. The suet plug kit of claim 2, wherein said at least one tubular mold is cylindrical.

4. The suet plug kit of claim 3, wherein, said kit further includes a second tubular mold, the second tubular mold having a substantially constant cross-section along its longitudinal axis, said second piston has a cross-section fitting snugly in said second tubular mold.

5. The suet plug kit of claim 4, wherein said at least one first tubular mold is four first tubular molds each having a different length.

6. The suet plug kit of claim 5, wherein said at least one second tubular mold is four second tubular molds each having a different length.

7. A method of making a suet plug, comprising the steps of:
providing a mixture of configurable bird feet suet;
providing a suet plug kit for forming suet plugs, wherein said suet plug kit includes at least one first tubular mold having a longitudinal axis, and at least one ramrod, wherein said ramrod has a longitudinal shaft and a first piston connected to one end of said shaft and a second piston connected at an opposite end of said shaft.

8. The method of claim 7, further comprising the steps of
placing a first end of said at least one first tubular mold on a flat surface and adding said bird feed suet into an opposite end of said at least one first tubular mold;
packing said bird feed suet into said at least one first tubular mold with said first piston of said ramrod.

9. The method of claim 8, wherein said bird feed suet is added in an amount so as to achieve a desired packed bird feed suet length.

10. The method of claim 8, wherein said bird feed suet is added and packed so that said opposite end is coplanar with and upper surface of said first piston of said ramrod.

11. The method of claim 10, further comprising the steps of:
turning said at least one first tubular mold and said at least one ramrod upside down onto said second piston; and next
pulling down said at least one first tubular mold until said first end of said tubular mold is coplanar with a working face of the first piston.

12. The method of claim 11, further comprising the steps of:
removing the newly formed bird feeder suet plug from the first piston.
